(19) United States
(12) Patent Application Publication
(10) Pub. No.: US 2010/0203468 A1
(43) Pub. Date: Aug. 12, 2010

(54) DENTAL HAND PIECE PROVIDED WITH A DIRECTION INDICATING UNIT

(76) Inventor: Jennifer CHA, Las Vegas, NV (US)

Correspondence Address: Guice Patents PLLC, 12647 Galveston Court #302, Manassas, VA, 20112, US

(21) Appl. No.: 12/366,850

(22) Filed: Feb. 6, 2009

(51) Int. Cl. A61C 3/02

(52) U.S. Cl. 433/76

(57) ABSTRACT

In a dental hand piece with a direction indication unit in the dental hand piece of the present invention, the front end of a main body is provided with a direction indication unit such as a laser guider in order to generate light beams that are horizontal and vertical respectively from the front end, the horizontal light beam can be aligned with the biting surface of a tooth, while the vertical light beam is for indicating the position of the hole to be drilled on a jawbone, thereby, a dentist can conveniently judge to drill a correct hole that is perpendicular to the biting surface of the tooth for correctly implanting a fixture, thereby to largely increase the rate of success of the operation of tooth implanting.

### BACKGROUND OF THE INVENTION

1. Field of the Invention

The present invention relates to a dental hand piece, and especially to a dental hand piece of which a front end is provided with a direction indication unit for guiding the direction of drilling.

2. Description of the Prior Art

A dental hand piece is a necessary tool for dental therapy; it is used to do grinding on or drilling in a tooth within an oral cavity of a patient. Particularly, it is used to drill a hole in a jawbone having a natural tooth lost, then a screw shape fixture is implanted in, after the fixture is combined with the jawbone, an abutment is installed on the fixture with a screw, thereafter, an artificial tooth crown is mounted on the abutment.

Referring to FIG. 1, an area having a natural tooth lost on a jawbone 31 in an oral cavity 3 between teeth 33 may wilt to form a down arched dented portion 32, if a normal dental hand piece 9 is used to drill a hole in the jawbone 31, a dentist normally may drill a hole 34a which is not perpendicular to a surface for biting of a tooth, and is deviated from a correct hole 34b; thus a fixture implanted in the hole 34a will be deviated too, this may affect and make difficult of installing of an artificial tooth crown to result failure of the operation of tooth implanting. In view of this, the conventional dental hand piece needs to be improved.

### SUMMARY OF THE INVENTION

The present invention provides a dental hand piece with a direction indication unit against the defect of uneasiness for correctly positioning with a normal hand piece; in the dental hand piece of the present invention, the front end of a main body of it is provided with a direction indication unit such as a laser guider, in order to generate light beams that are horizontal and vertical respectively from the front end, the horizontal light beam can be aligned with the biting surface of a tooth, while the vertical light beam is for indicating the position of the hole to be drilled on a jawbone, thereby, a dentist can conveniently judge to drill a correct hole that is perpendicular to the biting surface of the tooth for correctly implanting a fixture, thereby to largely increase the rate of success of the operation of tooth implanting.

The present invention will be apparent in its structure and its way of using after reading the detailed description of the preferred embodiment thereof in reference to the accompanying drawings.

### BRIEF DESCRIPTION OF THE DRAWINGS

FIG. 1 is a schematic sectional view showing the error that is easily induced in drilling with a conventional dental hand piece;

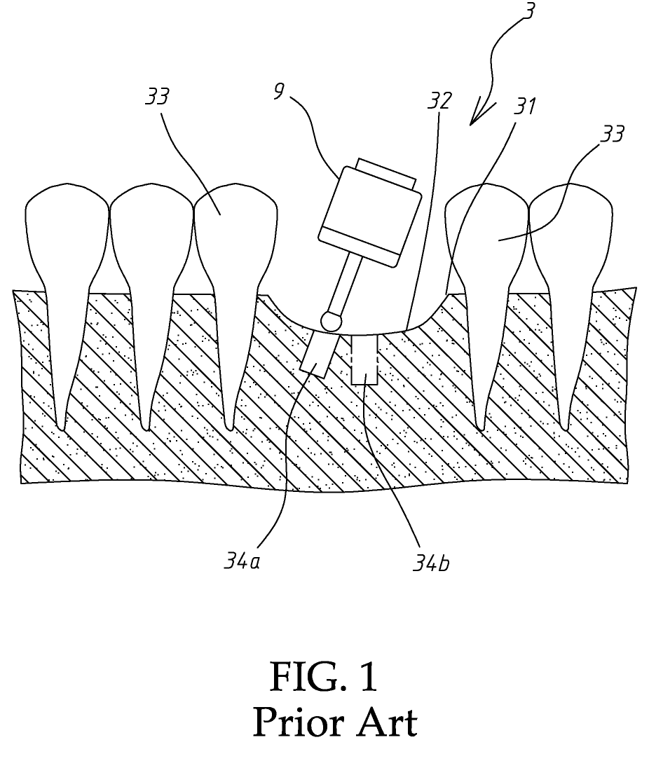

FIG. 2 is a plan view of the present invention;

FIG. 3 is a schematic sectional view showing use of the present invention.

### DETAILED DESCRIPTION OF THE PREFERRED EMBODIMENT

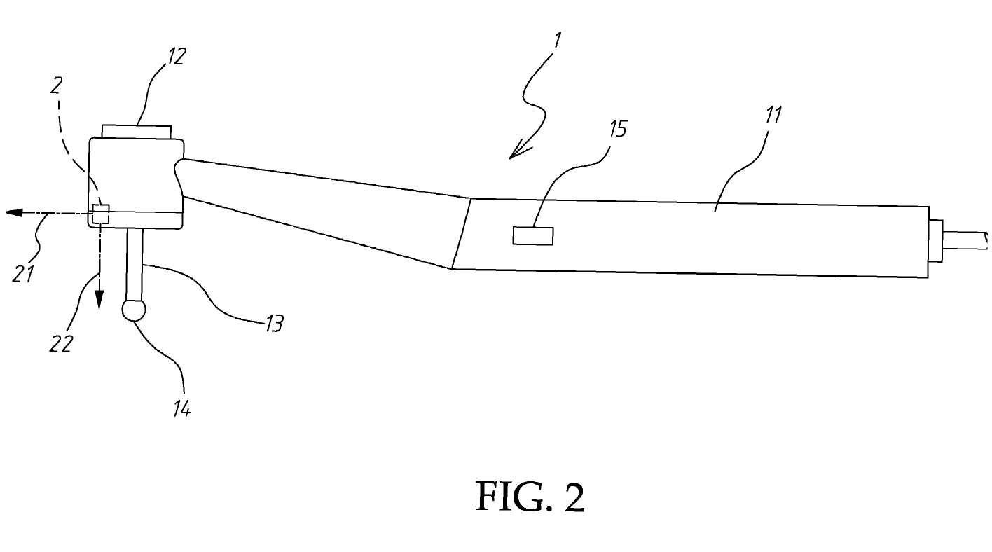

Referring to FIG. 2, a dental hand piece provided with a direction indication unit of the present invention comprises a main body 1 of the dental hand piece and a direction indication unit 2.

The main body 1 of the dental hand piece is identical to a main body of a conventional dental hand piece, it is provided with a handle 11 to be held by a dentist, a front end 12 of the main body 1 is formed thereon a rotative axle 13 perpendicular to the base of the front end 12, and the end of the rotative axle 13 has a drill 14 for grinding a tooth. The main improvement of the present invention is resided in that, the front end 12 of the main body 1 of the dental hand piece is provided with a direction indication unit 2, the direction indication unit 2 at least generates a horizontal light beam 21 and a vertical beam 22 respectively from the front end 12, the horizontal light beam 21 can be aligned with the biting surface of a tooth, while the vertical light beam 22 is for indicating the position of the hole to be drilled on a jawbone, and can guide a drill 14 to drill in a direction perpendicular to the biting surface. The horizontal and vertical light beams 21, 22 generated by the direction indication unit 2 can be laser light beams or any of some other lights without the possibility of making hurt. And more, the handle 11 of the main body 1 of the dental hand piece has a switch 15 in order to control turning on/off of the direction indication unit 2.

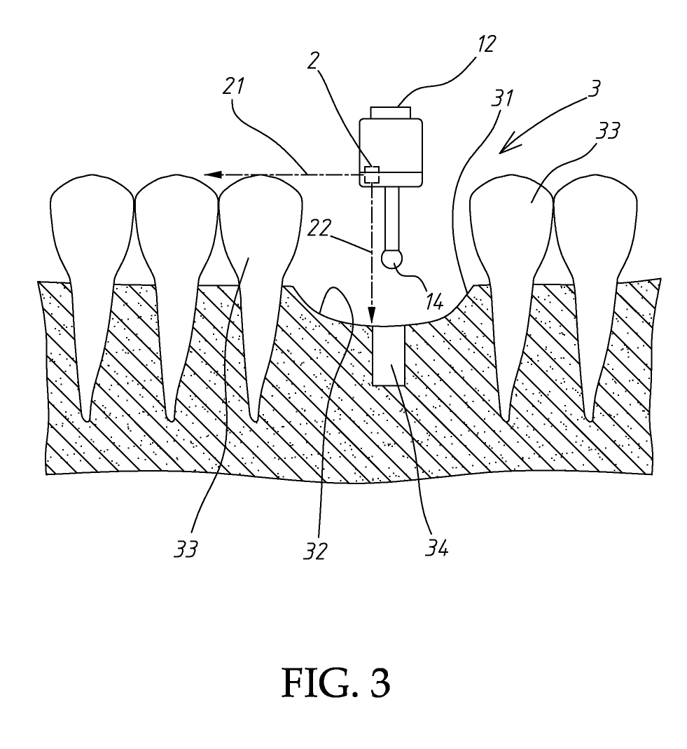

Referring to FIG. 3 showing use of the present invention, wherein when an area having a natural tooth lost on a jawbone 31 in an oral cavity 3 is drilled for implanting a fixture, the jawbone 31 having the natural tooth lost may wilt to form a down arched dented portion 32, thereby when a dentist wants to use the main body 1 of the dental hand piece of the present invention to drill a correct hole 34, he shall turn on the switch 15 firstly to make the direction indication unit 2 generate a horizontal light beam 21 and a vertical beam 22, and make the horizontal light beam 21 be aligned with the biting surface of a tooth 33, thus the vertical light beam 22 can indicate a correct direction for judgment of the dentist to render the drill 4 drill the correct hole 34 perpendicular to the surface for biting of the tooth 33 on the jawbone 31, so that the fixture can be correctly implanted, this can largely increase the rate of success of the operation of tooth implanting.

In conclusion, according to the description disclosed above, the dental hand piece provided with the direction indication unit of the present invention is an inventive structure coming from an improved designing, it can provide an extremely large effect. Having thus described the technical structure of my invention with practicability and improvement, what I claim as new and desire to be secured by Letters Patent of the United States is:

1. A dental hand piece provided with a direction indication unit, said dental hand piece comprises:
a main body provided with a handle to be held by a dentist, a front end of said main body is formed thereon a rotative axle perpendicular to a base of said front end, and an end of said rotative axle has a drill for grinding a tooth; and
a direction indication unit provided on said front end of said main body of said dental hand piece, said direction indication unit at least generates a horizontal light beam and a vertical beam respectively from said front end, said horizontal light beam is aligned with a biting surface of said tooth, while said vertical light beam is for indicating position of a hole to be drilled on a jawbone.

2. The dental hand piece provided with a direction indication unit as claimed in claim 1, wherein said horizontal and vertical light beams generated by said direction indication unit are laser light beams.

3. The dental hand piece provided with a direction indication unit as claimed in claim 1, wherein said handle of said main body of said dental hand piece has a switch, in order to control turning on/off of said direction indication unit.
